(19) United States
(12) Patent Application Publication
(10) Pub. No.: US 2022/0007594 A1
(43) Pub. Date: Jan. 13, 2022

(54) STACKABLE PLANT GROW RACKS AND WATERING SYSTEM

(71) Applicant: William J. Keegan, Oakdale, CA (US)

(72) Inventor: William J. Keegan, Oakdale, CA (US)

(21) Appl. No.: 16/922,286

(22) Filed: Jul. 7, 2020

(51) Int. Cl. A01G 9/24; A01G 9/02

(52) U.S. Cl. CPC A01G 9/247; A01G 9/022

(57) ABSTRACT

A stackable plant grow rack and watering system that includes a watering loop and a plurality of support loops stackable thereupon in a vertical direction. A plurality of stackable grow racks can be provided and spaced from one another and connected in series via connectable water hoses to thereby form a plant support and watering daisy-chain.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of stackable plant grow racks that include watering and support loops.

### 2. Description of the Related Art

When a plant grows vertically they tend to become top heavy and fall over to the side and onto the ground which impedes growth and could result in the death of the plant. Furthermore, providing water to such plants can be a tedious and laborious task. Therefore, a need exists to develop a system that can provide proper support and water means throughout the life cycle of these plants.

Various attempts have been made to solve the above-mentioned problems such as those found in Australian Patent 2014208274 to Chang; U.S. Pat. No. 6,840,008 to Bullock et al; and U.S. Pat. No. 8,857,103 to Coon. These prior art references are representative of prior plant support and watering systems. However, none of the above inventions and patents, taken either singly or in combination, is seen to describe the invention as claimed.

### BRIEF SUMMARY OF THE INVENTION

In view of the foregoing disadvantages inherent in the known art, the present invention provides stackable plant grow racks with watering and support loops. The general purpose of the present invention, which will be described subsequently in greater detail, is to provide a system that can provide proper support and watering means throughout the life cycle of growing plants.

The instant stackable plant grow racks each include a watering loop and a plurality of support loops stackable thereupon in a vertical direction. A plurality of stackable grow racks can be spaced from one another and connected in series via connectable water hoses to thereby form a watering “daisy chain”.

The main features of the instant stackable plant grow racks that is an improvement over the prior art stackable plant grow racks is the way the instant stackable plant grow racks can provide water to a plant while supporting its growth. Furthermore, the instant stackable plant grow racks can provide water and growth support to a plurality of plants simultaneously.

The instant stackable plant grow racks each include a watering loop and successive support loops stackable thereupon. Furthermore, water hoses are connected between each successive watering loop to form a “daisy chain” of stackable plant grow racks for use in any gardening scenario.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention constructed and operative according to the teachings of the present invention.

FIG. 1 shows a perspective view illustrating a stackable plant grow rack and watering system according to an embodiment of the present invention.

FIG. 2 shows a perspective view illustrating a plurality of stackable plant grow racks and watering system in a daisy chain configuration according to the embodiment of the present invention of FIG. 1.

FIG. 3 shows a cross-sectional view of an adjustable water flow nozzle attached to a watering loop according to the embodiment of the present invention of FIG. 1.

The various embodiments of the present invention will hereinafter be described in conjunction with the appended drawings, wherein like designations denote like elements.

### DESCRIPTION OF THE PREFERRED EMBODIMENT

The preferred embodiment of the present invention relates to stackable plant grow racks and watering system.

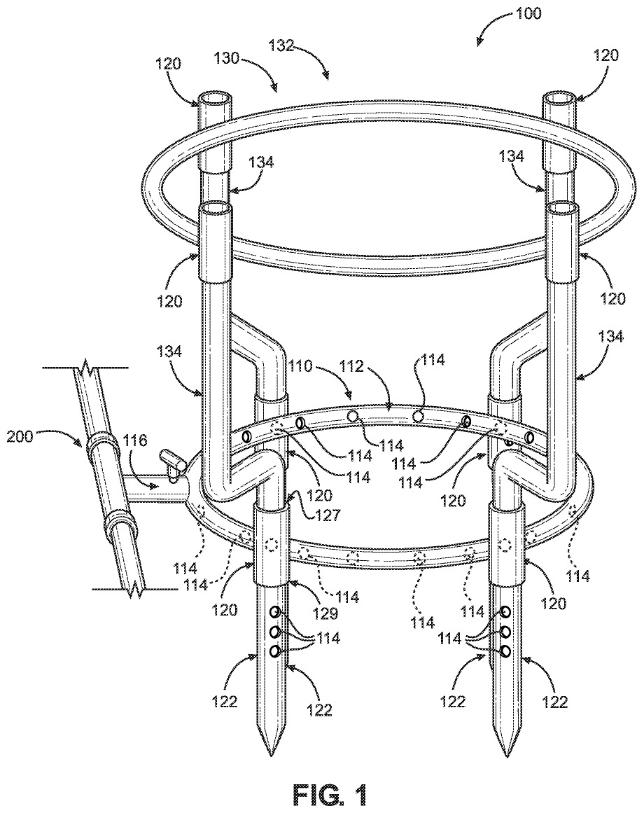

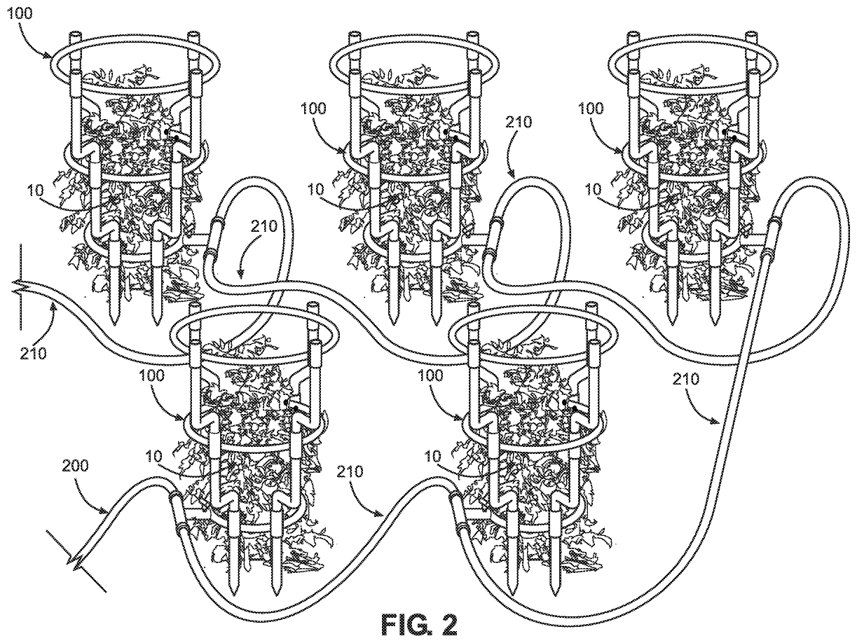

Referring now to FIGS. 1-2, a system of supporting and watering plants 10 comprises a plurality of stackable plant grow racks 100, each comprising a watering loop 110 including a circulation tube 112 including a plurality of spaced holes 114 therethrough, and an adjustable water flow nozzle 116, wherein the adjustable inflow nozzle is adapted to releasably secure a watering source hose thereto and allow water to pass therethrough and through the circulation tube at a chosen flow rate, wherein the circulation tube is formed having a shape adapted to surround a plant and allow the plant to grow through a center section formed by the shape, wherein the circulation tube is further adapted to support the plant as the plant grows through the center section, and wherein the circulation tube is adapted to allow water to circulate therethrough and exit through the plurality of spaced holes to thereby provide water to the plant while being supported by the stackable plant grow rack. The stackable plant grow racks each further include a plurality of support leg connectors 120, each including a top opening 127, a bottom opening 129; and a hole 114 in a center section thereof, wherein each of the plurality of support leg connectors 120 are hollow, are connected to the circulation tube of the watering loop such that each hole aligns with a respective hole of the circulation tube, are spaced from one another; and are adapted to allow water to pass therethrough; and wherein each of the plurality of support leg connectors are adapted to releasably hold a support leg within the top opening, and releasably hold a base leg within the bottom opening; and a plurality of base legs 122 each including a plurality of spaced holes 114 therethrough, wherein the plurality of base legs are spaced from one another and attached to the watering loop via respective support leg connectors at respective proximal ends thereof, wherein the plurality of base legs are hollow and adapted to allow water to pass from respective support leg connectors therethrough and exit through the plurality of spaced holes to thereby provide water to the plant while being supported by the stackable plant grow rack, and wherein the plurality of base legs 122 are adapted to be inserted into ground soil via respective distal ends thereof to thereby support the watering loop above the ground soil. The stackable plant grow racks each further include at least one support loop 130 comprising a support ring 132 formed having a shape adapted to surround the plant and allow the plant to grow through a center section formed by the shape, wherein the support ring is further adapted to support the plant as the plant grows through the center section, and wherein the center section of the support ring is larger than the center section formed by the circulation tube, such that as the plant grows larger the support ring is adapted to support the growing plant, a plurality of support leg connectors 120 spaced from one another and attached to the support ring and adapted to releasably attach a plurality of support legs thereto, and a plurality of support legs 134 spaced from one another and attached to the support ring via the respective plurality of support leg connectors at respective proximal ends thereof, and wherein the plurality of support legs are adapted to be releasably attached to the plurality of support leg connectors of the circulation tube of the watering loop via respective distal ends thereof to thereby support the support ring above the circulation tube, wherein the at least one support ring is adapted to be placed in concentric alignment with the circulation tube.

The system of supporting and watering plants further comprise a water source hose 200 adapted to be releasably connected to a water source at one end thereof and releasably connected to the adjustable water flow nozzle 116 of the circulation tube of the watering loop of a first of the plurality of stackable plant grow racks at an opposite end thereof; and a plurality of water hoses 210, wherein the plurality of water hoses are adapted to be releasably connected between adjustable water flow nozzles of each stackable plant grow rack, to thereby form an in-series (daisy-chain) watering system between the plurality of stackable plant grow racks 100, and thereby be capable of watering a plurality of plants at the same time.

The at least one support loop 130 may comprise a plurality of support loops 130, wherein the plurality of support loops are adapted to be stacked one on top of another, and wherein each successive support loop has a larger center section than a previous one of the plurality of support loops, such that as the plant grows taller and larger the plurality of support loops are able to support the plant throughout its growth process while the watering loop continues to provide water to the plant. In one embodiment, there are three support leg connectors 120 on the watering loop, three support leg connectors on the at least one support loop, three support legs on the watering loop, and three support legs on the at least one support loop. In another embodiment, there are four support leg connectors on the watering loop, four support leg connectors on the at least one support loop, four support legs on the watering loop, and four support legs on the at least one support loop. In following, there can be four support leg connectors 120 on the watering loop, four support leg connectors on the at least one support loop, four support legs on the watering loop, and four support legs on the at least one support loop.

The shape of the circulation tube of the watering loop may be formed as a circle or a polygon, and the shape of said support ring of the at least one support loop may be formed as a circle or a polygon.

The watering loop and the at least one support loop may be formed from copper, stainless steel, plastic, or polyvinyl chloride. The plurality of support legs of the watering loop is formed having a preferred length of approximately 16 inches, though other dimensions are obvious variations, and wherein the support legs are adapted to be inserted into the ground soil to a depth of approximately 8 inches, though other dimensions are obvious variations. The plurality of support legs of the at least one support loop may be formed having a length of between 6 inches and 8 inches, though other dimensions are obvious variations.

In another embodiment, there are five support loops 130, and wherein the respective support rings of the five support loops are adapted to be placed in concentric alignment with each other and the circulation tube. Furthermore, the plurality of support legs 134 can be formed having varying shapes and sizes, including curved, straight, bent, and S-shaped, depending on the type of plants being supported and watered or the size and shape of an existing garden. As such, each of the stackable plant grow racks can have unique shape, such as cone-shaped, or form a rectangular volume, or even odd shapes to properly support plants that take an unexpected growth shape. The number of base legs 122 and support legs 134 can also vary, i.e., 3, 4, or 5, or more, depending on the strength or size of the stackable plant grow racks needed. Furthermore, the plurality of support leg connectors can be formed as known slip joints, coupler joints, slide joints, stackable joints, and sleeve joints.

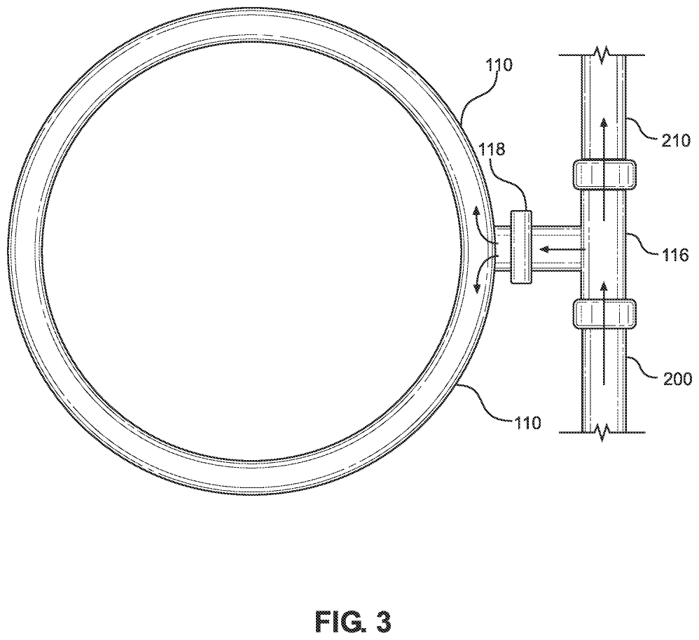

Referring now to FIG. 3, the adjustable water flow nozzle 116 includes a control knob 118 that is rotated to control the water flow rate, water flow arrows shown, to each watering loop 110. As such, the water flow rate to each stackable plant grow rack in a series of stackable plant grow racks can be controlled individually. Within the preferred embodiment the water flow nozzle 116 is T-shaped. However, other shapes, such as Y-shaped, could be used depending on the water flow rates desired or the dimensions and orientations of plants within a garden.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A stackable plant grow rack comprising:
a watering loop including:
a circulation tube including:
a plurality of spaced holes therethrough;
an adjustable water flow nozzle;
wherein said adjustable water flow nozzle is adapted to releasably secure water hoses thereto and allow water to pass into said circulation tube at a chosen flow rate;
wherein said circulation tube is formed having a shape adapted to surround a plant and allow said plant to grow through a center section formed by said shape;
wherein said circulation tube is further adapted to support said plant as said plant grows through said center section; and
wherein said circulation tube is adapted to allow water to circulate therethrough and exit through said plurality of spaced holes to thereby provide water to said plant while being supported by said stackable plant grow rack;
a plurality of support leg connectors, each including:
a top opening;
a bottom opening; and
a hole in a center section thereof;
wherein each of said plurality of support leg connectors are hollow, are connected to said circulation tube of said watering loop such that each said hole aligns with a respective hole of said circulation tube, are spaced from one another; and are adapted to allow water to pass therethrough; and
wherein each of said plurality of support leg connectors are adapted to releasably hold a support leg within said top opening, and releasably hold a base leg within said bottom opening; and
a plurality of base legs, each including:
a plurality of spaced holes therethrough;
wherein said plurality of base legs are spaced from one another and attached to said watering loop via respective said plurality of support leg connectors at respective proximal ends thereof;
wherein said plurality of base legs are hollow and adapted to allow water to pass from respective said support leg connectors therethrough and exit through said plurality of spaced holes to thereby provide water to said plant while being supported by said stackable plant grow rack; and
wherein said plurality of base legs are adapted to be inserted into ground soil via respective distal ends thereof to thereby support said watering loop above said ground soil; and
at least one support loop comprising:
a support ring;
wherein said support ring is formed having a shape adapted to surround said plant and allow said plant to grow through a center section formed by said shape;
wherein said support ring is further adapted to support said plant as said plant grows through said center section; and
wherein said center section of said support ring is larger than said center section formed by said circulation tube, such that as said plant grows larger said support ring is adapted to support said growing plant;
a plurality of support leg connectors;
wherein said plurality of support leg connectors are spaced from one another and attached to said support ring, and adapted to releasably attach a plurality of support legs thereto; and
a plurality of support legs;
wherein said plurality of support legs are spaced from one another and attached to said support ring via said respective said plurality of support leg connectors at respective proximal ends thereof; and
wherein said plurality of support legs are adapted to be releasably attached to said plurality of support leg connectors of said circulation tube of said watering loop and any one of said at least one support loop via respective distal ends thereof to thereby support each respective said support ring above said circulation tube;
wherein said at least one support ring is adapted to be placed in concentric alignment with said circulation tube.

2. wherein said at least one support loop comprises a plurality of support loops; wherein said plurality of support loops are adapted to be stacked one on top of another; and wherein each successive support loop has a larger center section than a previous one of said plurality of support loops, such that as said plant grows taller and larger said plurality of support loops are able to support said plant throughout its growth process while said watering loop continues to provide water to said plant.

3. The stackable plant grow rack of claim 1, wherein there are three said plurality of support leg connectors on said watering loop, three said plurality of support leg connectors on said at least one support loop, three said support legs on said watering loop, and three said support legs on said at least one support loop.

4. The stackable plant grow rack of claim 1, wherein there are four said plurality of support leg connectors on said watering loop, four said plurality of support leg connectors on said at least one support loop, four said support legs on said watering loop, and four said support legs on said at least one support loop.

5. The stackable plant grow rack of claim 1, wherein said shape of said circulation tube of said watering loop is formed as a circle; and said shape of said support ring of said at least one support loop is formed as a circle.

6. The stackable plant grow rack of claim 1, wherein said shape of said circulation tube of said watering loop is formed as a polygon; and said shape of said support ring of said at least one support loop is formed as a polygon.

7. The stackable plant grow rack of claim 1, wherein said watering loop and said at least one support loop are formed from a material chosen from a group of materials consisting of copper, stainless steel, plastic, and polyvinyl chloride.

8. The stackable plant grow rack of claim 1, wherein said plurality of base legs of said watering loop is formed having a length of approximately 16 inches, and wherein said base legs are adapted to be inserted into said ground soil to a depth of approximately 8 inches.

9. The stackable plant grow rack of claim 1, wherein said plurality of support legs of said at least one support loop is formed having a length of between 6 inches and 8 inches.

10. The stackable plant grow rack of claim 1, wherein there are five said support loops; and wherein said respective support rings of said five support loops are adapted to be placed in concentric alignment with each other and said circulation tube.

11. A system of supporting and watering plants comprising:
a plurality of stackable plant grow racks, each comprising:
a watering loop including:
a circulation tube including:
a plurality of spaced holes therethrough;
an adjustable water flow nozzle;
wherein said adjustable water flow nozzle is adapted to releasably secure water hoses thereto and allow water to pass into said circulation tube at a chosen flow rate;
wherein said circulation tube is formed having a shape adapted to surround a plant and allow said plant to grow through a center section formed by said shape;
wherein said circulation tube is further adapted to support said plant as said plant grows through said center section; and
wherein said circulation tube is adapted to allow water to circulate therethrough and exit through said plurality of spaced holes to thereby provide water to said plant while being supported by said stackable plant grow rack;
a plurality of support leg connectors, each including:
a top opening;
a bottom opening; and
a hole in a center section thereof;
wherein each of said plurality of support leg connectors are hollow, are connected to said circulation tube of said watering loop such that each said hole aligns with a respective hole of said circulation tube, are spaced from one another; and are adapted to allow water to pass therethrough; and
wherein each of said plurality of support leg connectors are adapted to releasably hold a support leg within said top opening, and releasably hold a base leg within said bottom opening; and
a plurality of base legs, each including:
a plurality of spaced holes therethrough;
wherein said plurality of base legs are spaced from one another and attached to said watering loop via respective said plurality of support leg connectors at respective proximal ends thereof;
wherein said plurality of base legs are hollow and adapted to allow water to pass from respective said support leg connectors therethrough and exit through said plurality of spaced holes to thereby provide water to said plant while being supported by said stackable plant grow rack; and
wherein said plurality of base legs are adapted to be inserted into ground soil via respective distal ends thereof to thereby support said watering loop above said ground soil; and
at least one support loop comprising:
a support ring;
wherein said support ring is formed having a shape adapted to surround said plant and allow said plant to grow through a center section formed by said shape;
wherein said support ring is further adapted to support said plant as said plant grows through said center section; and
wherein said center section of said support ring is larger than said center section formed by said circulation tube, such that as said plant grows larger said support ring is adapted to support said growing plant;
a plurality of support leg connectors;
wherein said plurality of support leg connectors are spaced from one another and attached to said support ring, and adapted to releasably attach a plurality of support legs thereto; and
a plurality of support legs;
wherein said plurality of support legs are spaced from one another and attached to said support ring via said respective said plurality of support leg connectors at respective proximal ends thereof; and
wherein said plurality of support legs are adapted to be releasably attached to said plurality of support leg connectors of said circulation tube of said watering loop and any one of said at least one support loop via respective distal ends thereof to thereby support each respective said support ring above said circulation tube;
wherein said at least one support ring is adapted to be placed in concentric alignment with said circulation tube;
a water source hose;
wherein said water source hose is adapted to be releasably connected to a water source at one end thereof, and releasably connected to said adjustable water flow nozzle of said circulation tube of said watering loop of a first of said plurality of stackable plant grow racks at an opposite end thereof; and
a plurality of water hoses;
wherein said plurality of water hoses are adapted to be releasably connected between adjustable water flow nozzles of each stackable plant grow rack, to thereby form an in-series watering system between said plurality of stackable plant grow racks, and thereby be capable of supporting and watering a plurality of plants at the same time.

12. The stackable plant grow rack of claim 11, wherein said at least one support loop comprises a plurality of support loops; wherein said plurality of support loops are adapted to be stacked one on top of another; and wherein each successive support loop has a larger center section than a previous one of said plurality of support loops, such that as said plant grows taller and larger said plurality of support loops are able to support said plant throughout its growth process while said watering loop continues to provide water to said plant.

13. The stackable plant grow rack of claim 11, wherein there are three said plurality of support leg connectors on said watering loop, three said plurality of support leg connectors on said at least one support loop, three said support legs on said watering loop, and three said support legs on said at least one support loop.

14. The stackable plant grow rack of claim 11, wherein there are four said plurality of support leg connectors on said watering loop, four said plurality of support leg connectors on said at least one support loop, four said support legs on said watering loop, and four said support legs on said at least one support loop.

15. The stackable plant grow rack of claim 11, wherein said shape of said circulation tube of said watering loop is formed as a circle; and said shape of said support ring of said at least one support loop is formed as a circle.

16. The stackable plant grow rack of claim 11, wherein said shape of said circulation tube of said watering loop is formed as a polygon; and said shape of said support ring of said at least one support loop is formed as a polygon.

17. The stackable plant grow rack of claim 11, wherein said watering loop and said at least one support loop are formed from a material chosen from a group of materials consisting of copper, stainless steel, plastic, and polyvinyl chloride.

18. The stackable plant grow rack of claim 11, wherein said plurality of base legs of said watering loop is formed having a length of approximately 16 inches, and wherein said base legs are adapted to be inserted into said ground soil to a depth of approximately 8 inches.

19. The stackable plant grow rack of claim 11, wherein said plurality of support legs of said at least one support loop is formed having a length of between 6 inches and 8 inches.

20. The stackable plant grow rack of claim 11, wherein there are five said support loops; and wherein said respective support rings of said five support loops are adapted to be placed in concentric alignment with each other and said circulation tube.
